(19) United States
(12) Patent Application Publication
(10) Pub. No.: US 2005/0074211 A1
(43) Pub. Date: Apr. 7, 2005

(54) Sleeve receiving element for the coupling of an optical plug-type connector

(76) Inventor: Daniel Greub, St. Gallen (CH)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(21) Appl. No.: 10/502,416

(22) PCT Filed: Nov. 21, 2002
(86) PCT No.: PCT/CH02/00628

(30) Foreign Application Priority Data
Jan. 24, 2002 (CH) 113/02

(51) Int. Cl. G02B 6/36

(52) U.S. Cl. 385/55; 385/78

(57) ABSTRACT

Disclosed is a sleeve mount with an interior for accommodating and securing a longitudinally slit, cylindrical sleeve, which is provided in the coupling of an optical plug-in connection for accommodating the ferrules of two optical plug-in connectors which are introduced from opposite sides, the sleeve mount having means for securing the sleeve against rotation about the sleeve axis. A maximum level of freedom of movement of the sleeve in the interior is easily achieved in that the rotation-prevention means are arranged in the central part of the sleeve mount and are restricted to the central part of the sleeve mount.

### TECHNICAL FIELD

The present invention deals with the field of optical plug-in connectors. It relates to a sleeve mount for the coupling of an optical plug-in connection according to the preamble of claim 1.

Such a sleeve mount is known, for example, from JP-A-60144707.

### PRIOR ART

For many years now, different types of plug-in connector known, for example, by the designations SC, FC or ST have proven successful in the field of optical plug-in connections. In the case of these plug-in connectors, the ends of optical fibres terminated by the plug-in connector are adhesively bonded in the central bore of a ferrule, which usually consists of a precision-ceramic material. In order to connect two optical fibres to one another, the associated plug-in connectors are plugged into a coupling from opposite sides. The ferrules here are pushed from opposite sides into a longitudinally slit guide sleeve, which is mounted with play in the coupling, until their end sides butt against one another (see, for example, U.S. Pat. No. 5,781,680).

Since the core of such an optical fibre is very thin, suitable measures have to be taken in order to ensure that a sufficient optical coupling can regularly be produced between the cores of the optical fibres which are to be connected, even in the case of repeated plug-in operations. One of these measures consists, for example, in each of the plug-in connectors being provided, in a predetermined manner, with a fixed orientation in the direction of rotation about the plug axis (see U.S. Pat. No. 4,738,508 in this respect).

More precise tests have shown that, in order to achieve a reliable optical connection even in the case of repeated plug-in operations, it is of critical importance for the guide sleeve arranged in the coupling also to be mounted in a rotationally fixed manner. This is attributed, inter alia, to the particular mechanical properties of a longitudinally slit, hollow-cylindrical sleeve.

JP-A-60144707, which was mentioned in the introduction, has proposed, for the purpose of mounting the slit sleeve in a rotationally secure manner, a sleeve mount (FIG. 5) which, in its interior provided for accommodating the sleeve, has a longitudinally running groove made in the wall. On the sleeve, which has been bent in round form from a sheet-metal portion, either a longitudinally continuous lug or two lugs are provided at the ends of the sleeve, these being bent radially outwards at right angles and engaging, as rotation-prevention means, in the groove of the sleeve mount. Also shown as a rotation-prevention means, however, is a longitudinally running rib (FIG. 1) which is integrally formed on the inner wall of the sleeve mount and engages in the radially inward direction in the longitudinal slit of the sleeve.

These known rotation-prevention means, however, have disadvantages: the sleeves are mounted with play in the sleeve mount, with the result that they can be adapted by corresponding tilting to the plugged-in plug-in connectors. If the rotation-prevention means, however, extends over the entire length of the sleeve or is fitted at both ends of the sleeve—as is proposed in JP-A-60144707—the free play of the sleeve in the sleeve mount is restricted to a considerable extent. Such a restriction, however, adversely affects the quality of the plug-in operation and of the optical connection.

Specifically the bent lugs on the sleeves produced from a sheet-metal portion are difficult to produce and cannot be realized, in practice, for sleeves which consist of ceramic material. Furthermore, the lugs change the mechanical behaviour of the sleeve, which can adversely affect the guidance function of the sleeves.

### DESCRIPTION OF THE INVENTION

The object of the invention is thus to provide a sleeve mount with a rotation-prevention means for the sleeve which avoids the disadvantages of the known solutions and, in particular, only insignificantly impairs the play of the sleeve in the sleeve mount.

The object is achieved by all the features of claim 1. The core of the invention consists in arranging the rotation-prevention means in the central part of the sleeve mount and in restricting them to the central part of the sleeve mount. This ensures that the sleeve is only obstructed from rotating about the sleeve axis, but can otherwise be tilted, for the most part, in all directions about a central point and can thus be optimally adapted to the plugged-in plug-in connectors.

There are different preferred configurations of the invention for the case where the sleeve mount is formed in one piece:

A first preferred configuration is distinguished in that the sleeve mount, in the central part, has a radial bore through which a pin projects into the interior and engages in the slit of the slit sleeve. In order to prevent the plug-in operation from being obstructed in any way by the pin, it is advantageous here if the pin is designed such that it engages in the slit of the slit sleeve without projecting into the interior of the sleeve. The engagement of the pin in the slit here is facilitated by the pin tapering conically at its end which engages in the slit.

If the sleeve mount comprises two coaxial, hollow-cylindrical accommodating parts which are arranged one behind the other and between which a central part in the form of a flange is arranged, it is expedient if the bore runs within the flange.

A second preferred configuration, which is distinguished by particular simplicity in production and application, is characterized in that the sleeve mount, in the central part, has a protuberance which projects into the interior and engages in the slit of the slit sleeve.

The protuberance is preferably of elongate design and extends in longitudinal direction of the sleeve mount. In order to facilitate the engagement in the slit, it has a triangular cross section. It is also preferably designed such that it engages in the slit of the slit sleeve without projecting into the interior of the sleeve.

If the sleeve mount is made up of two separate accommodating parts, it is particularly straightforward in production terms if the rotation-prevention means are arranged and retained between the accommodating parts.

This may be done, in particular, such that, at their mutually opposite ends, the accommodating parts have flange parts which butt against one another when the accommodating parts are put together, and that the rotation-prevention means comprise a securing plate which is retained in a rotationally secure manner between the flange parts and engages in the slit of the slit sleeve by way of a protuberance. The situation where the securing plate is secured in a rotationally secure manner is preferably achieved in that the flange parts contain depressions for accommodating the securing plate, and in that the depressions each have a peripheral contour which is adapted to the peripheral contour of the securing plate.

The securing plate preferably has a central opening through which the sleeves can be plugged, the protuberance being arranged in a periphery of the opening and being designed such that it engages in the slit of the slit sleeve without projecting into the interior of the sleeve.

Further embodiments can be gathered from the dependent claims.

### BRIEF EXPLANATION OF THE FIGURES

The invention will be explained in more detail hereinbelow with reference to exemplary embodiments in conjunction with the drawing, in which:

FIG. 1 shows a perspective side view of a sleeve mount according to a first preferred exemplary embodiment of the invention with a rotation-prevention means in the form of a pin;

FIG. 2 shows the sleeve mount from FIG. 1 in longitudinal section;

FIG. 3 shows an exploded illustration of the sleeve mount from FIG. 1 with the associated sleeve and the associated pin;

FIG. 4 shows a perspective side view of a sleeve mount according to a second preferred exemplary embodiment of the invention with a rotation-prevention means in the form of an inner protuberance;

FIG. 5 shows the sleeve mount from FIG. 4 in longitudinal section;

FIG. 6 shows the view from the front of the sleeve mount from FIG. 4; and

FIG. 7 shows an exploded illustration of a two-part sleeve mount according to a further preferred exemplary embodiment of the invention with a centrally inserted securing plate provided with an inner protuberance.

### METHODS OF IMPLEMENTING THE INVENTION

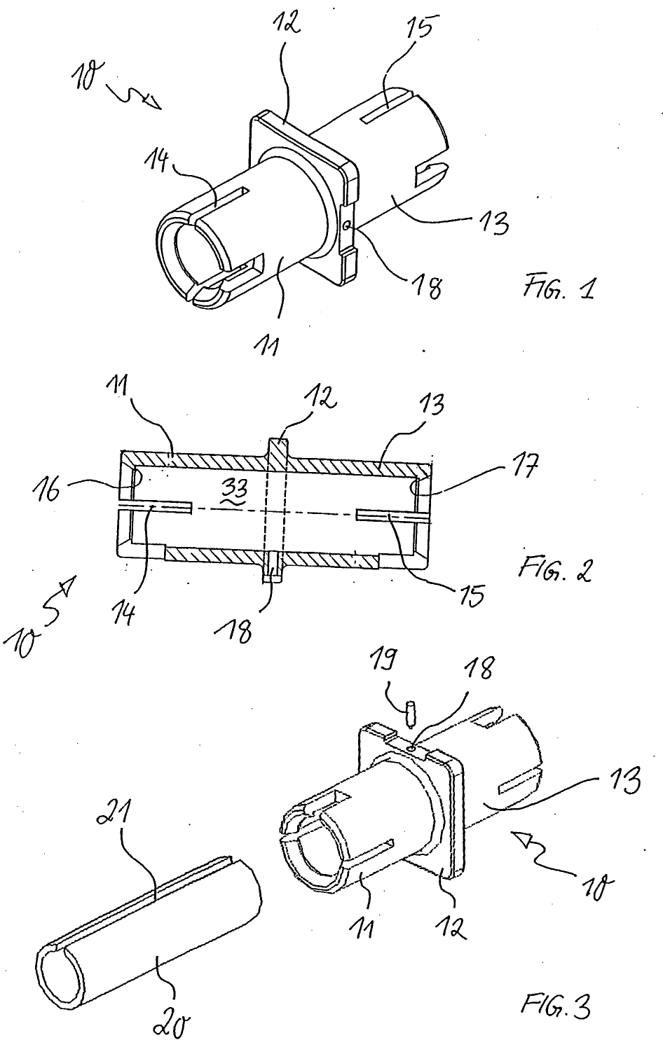

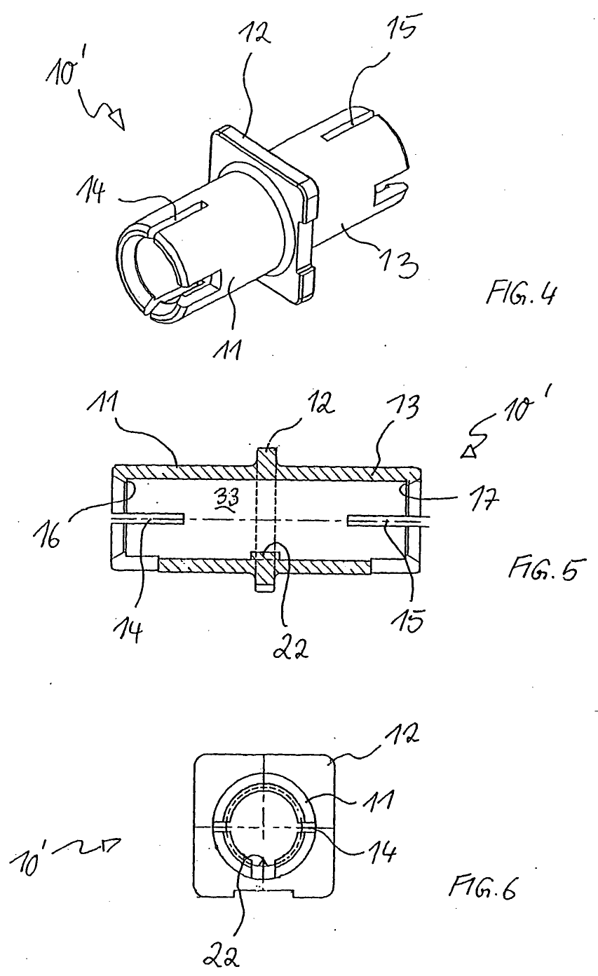

FIGS. 1 to 3 illustrate different views of a sleeve mount according to a first preferred exemplary embodiment of the invention with a rotation-prevention means in the form of a pin. The sleeve mount 10 is formed in one piece and is produced from a suitable plastic, for example, as an injection moulding. The sleeve mount 10, which extends longitudinally along the axis of the plug-in connector, is subdivided into three portions, namely a first hollow-cylindrical accommodating part 11, a flange 12 and a second hollow-cylindrical accommodating part 13. The three portions then close a continuous cylindrical interior 33 (FIG. 2), which accommodates and retains the slit sleeve 20 (FIG. 3). The sleeve 20 is prevented from sliding out of the interior 33 by undercuts 16, 17 being provided at the two outer ends of the accommodating parts 11, 13, the sleeve 20 latching in behind these undercuts when it is pushed into the sleeve mount 10. The operation of pushing the sleeve 20 into the interior 33 is facilitated by the accommodating parts 11, 13 having slots 14, 15 at their outer end, these slots allowing the slotted regions to widen elastically.

The outer dimensions of the sleeve 20 are such that the sleeve 20 has a sufficient amount of play in the interior 33 of the sleeve mount 10 and, in particular, can tilt away from the longitudinal axis. The sleeve 20 is prevented from rotating about its longitudinal axis in that a pin 19 projects radially into the interior 33 through a bore 18 in the flange 12 of the sleeve mount 10 and engages in the slit 21 of the sleeve 20. For the sake of simplicity here, the bore 18 runs parallel to one side of the rectangular or square flange 12. The pin 19 is designed such that it engages in the slit 21 of the slit sleeve 20 without projecting into the interior of the sleeve 20. This reliably avoids the situation where the pin 19 engaging in the slit 21 disrupts the operation of plugging in the plug-in connectors or ferrules. The pin 19 tapers conically at its end which engages in the slit 21. This facilitates the engagement in the slit 21 to a significant extent.

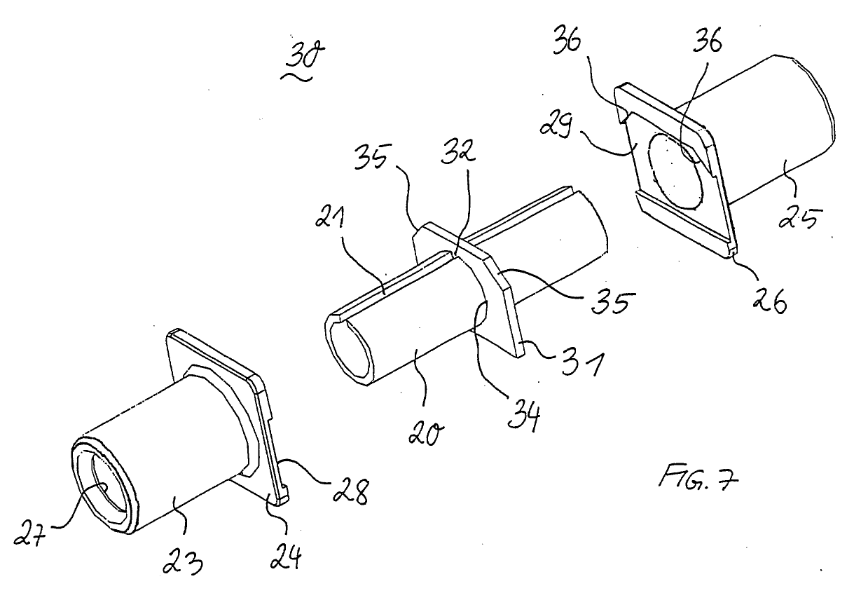

A further exemplary embodiment of the single-piece sleeve mount with a rotation-prevention means according to the invention is represented in FIGS. 4 to 6. The basic shape of the sleeve mount 10′ is largely identical to the sleeve mount 10 shown in FIGS. 1 to 3. The same parts are thus also provided with the same designation. Differences arise in respect of the rotation-prevention means. The rotation-prevention means of the sleeve mount 10′ is an inner protuberance 22 (FIG. 5) which is integrally formed on the wall of the interior 33, in the central section, extends longitudinally approximately over the region of the flange 12 and has a triangular cross section (FIG. 6). It thus has, in the plug-in direction, a contour which is comparable with the conically pointed pin 19 and is favourable for engagement in the slit 21. The protuberance 22 is also designed such that it engages in the slit 21 of the slit sleeve 20 without projecting into the interior of the sleeve 20. The length of the protuberance 22 is dimensioned such that it has sufficient mechanical strength without overly impairing the freedom of movement of the sleeve 20 in the interior 33.

Another possible rotation-prevention means is achieved if the sleeve mount, rather than being in one place, is made up of two halves which are essentially mirror-symmetrical in relation to a centre plane. Such a sleeve mount 30 is illustrated in FIG. 7. The sleeve mount 30 comprises two separate accommodating parts 23, 25 with an undercut 27. Since it is possible for the two accommodating parts 23, 25 to be pushed onto the sleeve 20 from two sides and then connected to one another, the accommodating parts 23, 25 need not be slotted at the outer ends. Both accommodating parts 23, 25 have a flange part 24, 26 integrally formed on the inner ends. The two flange parts 24, 26 form—if the two accommodating parts 23, 25 are connected to one another—a flange which is comparable with flange 12 from FIG. 1 or 4. Specifically contoured, flat depressions 28, 29 are provided in a mirror-inverted manner on the outside of the flange parts 24, 26, it being possible for these depressions to accommodate a securing plate 31 with a corresponding peripheral contour in a rotationally secure manner. The peripheral contours of the depressions 28, 29 and of the securing plate 31 here are preferably coordinated with one another such that the securing plate 31 (with the sleeve 20 plugged through it)—without rotating—has a sufficient amount of radial play.

In order that the securing plate 31 can only be accommodated in a certain angle-of-rotation orientation in the depressions 28, 29 of the accommodating parts 23, 25, means for defining the orientation are provided on the securing plate 31 and the accommodating parts 23, 25. In the exemplary embodiment of FIG. 7, these means are two bevels 35 at the (top) corners of the securing plate 31 and two corresponding bevels 36 on the peripheral contours of the depressions 28, 29.

The securing plate 31, which may be designed for example as a punched sheet-metal part, has a circular opening 34 in the centre, a triangular protuberance 32 being integrally formed on the inner periphery of this opening. The securing plate 31 can be pushed over the sleeve 20 by way of the opening, the protuberance 32 engaging in the slit 21. The protuberance 32 is preferably also designed such that it engages in the slit 21 of the slit sleeve 20 without projecting into the interior of the sleeve 20.

Overall, the invention provides a sleeve mount with rotation-prevention means for the sleeve which easily allows a maximum level of freedom of movement for the sleeve in the interior of the sleeve mount.

List of Designations

10, 10′, 30 (Single-piece) sleeve mount
11, 13 (Hollow-cylindrical) accommodating part
12 Flange
14, 15 Slot
16, 17, 27 Undercut
18 Bore
19 Pin
20 Sleeve
21 Slit
22, 32 Protuberance
23, 25 Accommodating part
24, 26 Flange part
28, 29 Depression
31 Securing plate
33 Interior (of sleeve mount)
34 Opening
35, 36 Bevel.

1-16. (cancelled)

17. A sleeve mount comprising an interior for accommodating and securing a longitudinally slit, cylindrical sleeve, the sleeve mount provided in a coupling of an optical plug-in connection for accommodating ferrules of two optical plug-in connectors introduced from opposite directions, the sleeve mount having means for securing the sleeve against rotation about a sleeve axis, wherein rotation-prevention means are arranged in a central part of the sleeve mount and are restricted to the central part of the sleeve mount.

18. The sleeve mount according to claim 17, wherein the sleeve mount is formed in one piece.

19. The sleeve mount according to claim 18, wherein the sleeve mount, in the central part, has a radial bore and a pin projects through the radial bore and into an interior and engages in the slit of the slit sleeve.

20. The sleeve mount according to claim 19, wherein the pin is designed to engage in the slit of the slit sleeve without projecting into the interior of the sleeve.

21. The sleeve mount according to claim 19, wherein the pin tapers conically at an end and the end engages in the slit.

22. The sleeve mount according to claim 19, wherein the sleeve mount comprises two coaxial, hollow-cylindrical accommodating parts arranged one behind another, a central part in a form of a flange is arranged between the accommodating parts, and the bore runs within the flange.

23. The sleeve mount according to claim 22, wherein the flange has a rectangular peripheral contour, and the bore runs parallel to one of sides of the flange.

24. The sleeve mount according to claim 18, wherein the sleeve mount, in a central part, has a protuberance, the protuberance projects into an interior and engages in the slit of the slit sleeve.

25. The sleeve mount according to claim 24, wherein the protuberance is of elongate design and extends in a longitudinal direction of the sleeve mount, and the protuberance has a triangular cross section.

26. The sleeve mount according to claim 24, wherein the protuberance engages in the slit of the slit sleeve without projecting into the interior of the sleeve.

27. The sleeve mount according to claim 17, wherein the sleeve mount is made up of two separate accommodating parts, and the rotation-prevention means are arranged and retained between the accommodating parts.

28. The sleeve mount according to claim 27, wherein at mutually opposite ends of the accommodating parts, the accommodating parts have flange parts butting against one another when the accommodating parts are put together, and the rotation-prevention means comprise a securing plate retained in a rotationally secure manner between the flange parts and engaging in the slit of the slit sleeve by way of a protuberance.

29. The sleeve mount according to claim 28, wherein the flange parts contain depressions for accommodating the securing plate, and the depressions each have a peripheral contour adapted to a peripheral contour of the securing plate.

30. The sleeve mount according to claim 28, wherein the securing plate has a central opening, the sleeve is plugged through the central opening, and the protuberance is arranged on an inner periphery of the opening.

31. The sleeve mount according to claim 28, wherein the protuberance engages in the slit of the slit sleeve without projecting into an interior of the sleeve.

32. The sleeve mount according to claim 28, wherein the sleeve mount comprises means for defining the angle-of-rotation orientation provided on the securing plate and the accommodating parts.

33. The sleeve mount according to claim 23, wherein the peripheral contour is square.

34. The sleeve mount according to claim 29, wherein the peripheral contour allows radial play.

35. The sleeve mount according to claim 32, wherein the means for defining the angle-of-rotation orientation are bevels.
